(19) United States
(12) Patent Application Publication
(10) Pub. No.: US 2002/0017034 A1
(43) Pub. Date: Feb. 14, 2002

(54) 2-Step method for drying mash-products

(76) Inventor: Takanobu Suzuki, Iwaki-City (JP)

Correspondence Address: Brian J McNamara, Foley & Lardner, Washington Harbour, 3000 K Street N W Suite 500, Washinton, DC, 20007-5109, US

(21) Appl. No.: 09/559,649

(22) Filed: Apr. 28, 2000

(30) Foreign Application Priority Data
Mar. 21, 2000 (KR) 2000-142180

(51) Int. Cl. F26B 5/08

(52) U.S. Cl. 34/318

(57) ABSTRACT

The present invention relates to a method and device for drying mash-products, and more particularly to a 2-step device for drying mash-products comprising a first drying unit (a flow rotary drying unit) and a second drying unit (a mixing rotary drying unit), the first drying unit and the second drying unit being arranged in series, and a 2-step method for drying mash-products.

### BACKGROUND OF THE INVENTION

1. Field of the Invention

The present invention relates to a method and device for drying mash-products, and more particularly to a 2-step device for drying mash-products comprising a first drying unit (a flow rotary drying unit) and a second drying unit (a mixing rotary drying unit), the first drying unit and the second drying unit being arranged in a series, and a 2-step method for drying mash-products.

2. Background of the Related Art

Generally, there are used fish cakes or dried mash-products in the shape of a circular plate, a semicircular plate, a swirl, a rice cake with a orange pattern imprinted, a designed crab, a panda and other animals as a kind of seasoning ingredients of instant noodles, such as curled noodles and noodles in a bowl. the term of “mash-product” in this specification and claims means a product made from wheat flour dough and the like.

FIG. 4 is a schematic side cross-sectional view of a flow rotary drying device disclosed from Korean Patent No. 130127, which was published on Apr. 17, 1998 under Korean Patent Publication No. 130127/1998. The aforesaid patent discloses a method and device for drying mash-products consecutively characterized in that cut mash-products 105 are sorted by a mesh-type vibrating input feeder, then moved through into an input opening 107 by means of an input fan, dropped into an inlet of a drying can 101 by means of a screening plate 103, and then flowed and transferred to an output opening.

According to the aforesaid patent, however, if the speed of a hot wind 104 become increased in the vicinity of the inlet in order to make the mash-products be floated and flowed in the rotary drum, the mash-products are flown away to the output opening earlier than the predetermined time, resulting in poor mash-products which does not contain predetermined moisture therein.

In addition, if the mash-products are provided with reducing starchy resolution substance(for example, D-sorbitol, millet jelly, etc.) amount of which are more than in the prior art so as to prevent split of the mash-products, they adhere to one another during the drying operation. In order to prevent this phenomenon, the mash-products must be floated and flowed heavily until they contain moisture with which the mash-products adhere to one another. As the speed of the hot wind 104 increases in order to float and flow the mash-products heavily, the aforementioned phenomenon occurs more significantly, resulting in more poor mash-products.

### SUMMARY OF THE INVENTION

Therefore, the present invention is aimed to solve the aforementioned problems.

An object of the present invention is to provide a 2-step method for drying mash-products, comprising: the steps of carrying out a first drying operation of mash-products until the mash-products contain moisture by 25 to 35%, throwing the semi-dried mash-products in the improved unit of the same type in order to carry out a second drying operation, thereby it is possible to increase the speed of the hot wind during the first drying operation, and to adjust content of the moisture to the predetermined value finely.

Another object of the present invention is to provide a 2-step device for drying mash-products which carries out the aforesaid method.

Still another object of the present invention is to provide a method for drying mash-products, wherein a plurality of the teflon-coated metal nets, which are bent in the shape of mountains (i.e. corrugated), are arranged in the rotary drum during the second drying operation so that the inner surface area of the rotary drum becomes increase remarkably, the hot wind having a low speed of the hot wind is supplied, and the rotary drum is rotated at a rapid speed, thereby the number of contact between the mash-products and the hot wind, resulting in the rapid drying.

Another object of the present invention is to provide a 2-step device for drying mash-products which carries out the aforesaid method.

Still other object of the present invention is to provide a method for drying mash-products, wherein the temperature of the hot wind or the angle of inclination of the drum is adjusted finely during the second drying operation, thereby it is possible to adjust more finely and easily than the prior art, and wherein the angle of inclination of the drum is adjusted to the maximum after the drying operation, and at the same time the opening and closing unit of the output opening is fully opened, thereby it is possible to draw out the mash-products more rapidly and easily than the prior art.

Another object of the present invention is to provide a 2-step device for drying mash-products which carries out the aforesaid method.

### BRIEF DESCRIPTION OF THE DRAWINGS

The preferred embodiment of the present invention will be described in detail with reference to the accompanying drawings. In the drawings:

FIG. 1 is a schematic view showing a 2-step device for drying mash-products according to the present invention;

FIG. 2 is a schematic side cross-sectional view showing a second drying unit of the 2-step device for drying mash-products according to the present invention along a line X-X of FIG. 1;

FIG. 3 is a front view showing a second drying unit of the 2-step device for drying mash-products according to the present invention along a plane Y-Y of FIG. 1; and

FIG. 4 is a schematic side cross-sectional view of a flow rotary device for drying mash-products according to the prior art.

### DESCRIPTION OF PREFERRED EMBODIMENT OF THE INVENTION

The present invention will be described in further detail by way of example with reference to the accompanying drawings.

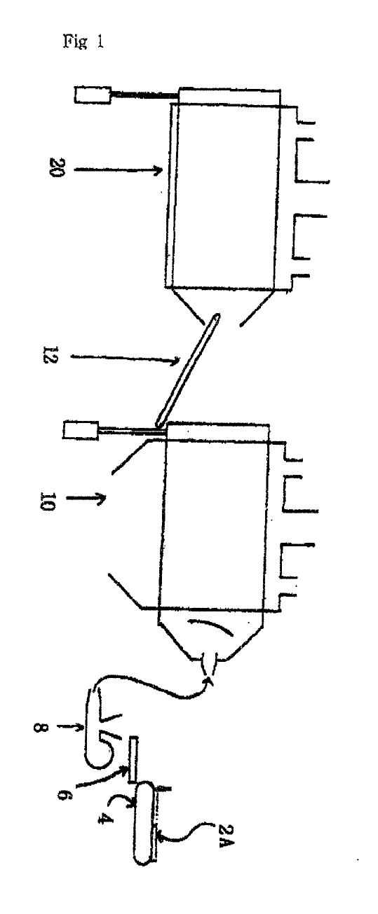

FIG. 1 is a schematic view showing a 2-step device for drying mash-products according to the present invention. Frozen mash-products 2A are cut to a predetermined thickness, for example 1.0 mm to 3.0 mm, by means of a cutting device 4. The cut mash-products 2A are transferred into a vibrating feeder 6 in the shape of nets, by which the mash-products are sorted and the poor mash-products are removed. The sorted good mash-products 2A are thrown into a first drying unit 10 by an air blast by means of an input fan 8. The mash-products 2B, which are dried in the first drying unit 10, are transferred into a second drying unit 20 by means of a input conveyor 12. The second drying operation is carried out in the second drying unit 20.

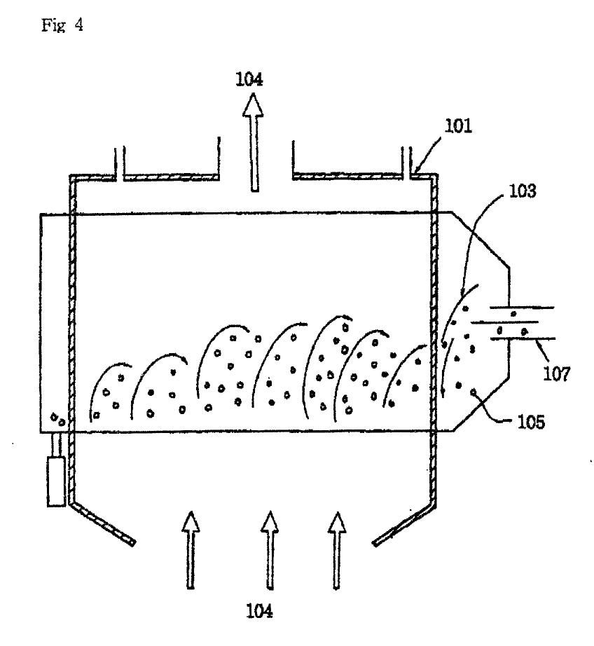

The first drying unit is a flow rotary drying unit in which a large quantity of the hot wind is supplied into the even rotary drum so as to float and flow the mash-products heavily, and mix the hot wind and the mash-products, resulting in uniform drying. The drum is rotated in order to prevent the mash-products from accumulating at a place where the hot wind is weak. The first drying unit is identical or similar to the drying device of the aforesaid patent shown in FIG. 4, thus the detailed description of the construction thereof will be omitted.

During the first drying operation, the mash-products, which are cut to a thickness of 1 mm to 3 mm, are input at the rate of 3 to 6 kg/min, and the drum is rotated at 4 to 5 rpm. The mash-products are dried continuously for 10 minutes to 20 minutes while the hot wind having the temperature of 50 to 70° C. is supplied to the inlet at the speed of 6 to 8 m/sec and to the outlet at the speed of 4 to 6 m/sec. As compared to the aforesaid patent, it is seen that as the flow rate of the hot wind is increased, the speed of the hot wind is increased, the speed of the hot wind which passes the surface of the mash-products is increased, the pressure on the mash-products is decreased, the drying time of the surfaces of the mash-products is decreased to prevent them from adhering to one another even though the temperature of the hot wind becomes low.

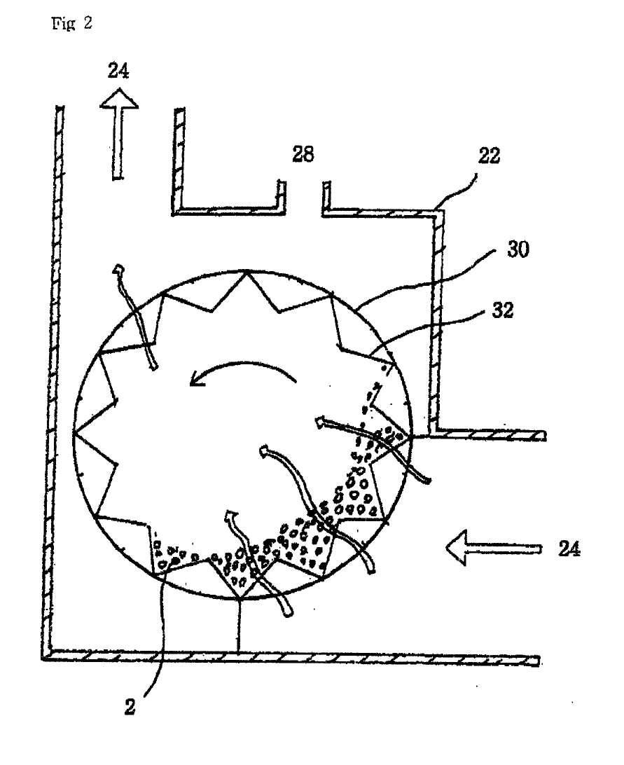

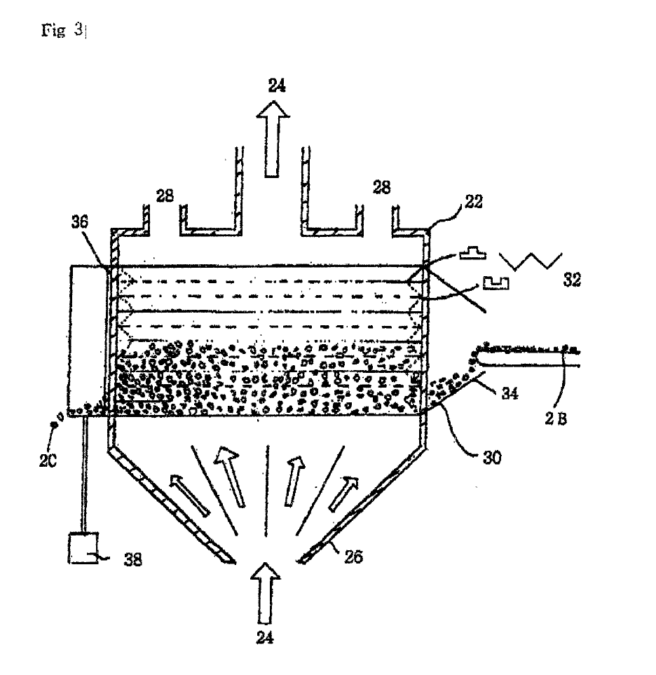

FIG. 2 is a schematic side cross-sectional view showing a second drying unit 20 of the 2-step device for drying mash-products according to the present invention along a line X-X of FIG. 1, and FIG. 3 is a front cross-sectional view showing a second drying unit of FIG. 2 along a plane Y-Y of FIG. 1. The second drying unit 20 is a mixing rotary drying unit. The hot wind is supplied into the rotary drum with the uneven surface such that the mash-products are floated or flowed. As the drum is rotated, the mash-products in the depressed portions are lifted to the upper portion of the drum and then dropped so that the mash-products are mixed with the hot wind, thereby the drying operation is carried out. At this time, if the rotating speed of the drum is increased, the number of mixture between the mash-products and the hot wind is increased, thereby it is possible to dry the mash-products uniformly.

Referring to FIG. 2 and FIG. 3, a drying can 22 of the second drying unit 20 is provided at the lower side portion thereof with a input opening 26 through which the hot wind 24 is input, and is provided at the upper portion thereof with a output opening 28 through which the wasted hot wind is discharged. The drum 30 is provided at the part thereof located inside the drying can 22 with holes and a plurality of depressed portions 32 made of teflon-coated metal and formed in the shape of mountains (i.e. corrugated). The drum is provided at one end thereof with an input opening 34, and is provided at the other end thereof with an output opening 36. Two or more dampers are provided for adjusting the flow rate of the hot wind 24, and a plunger 38 is provided for adjusting the angle of inclination of the drum 30.

During the second drying operation, the input conveyor 12, the blowing fan, the discharging fan, and the drum are rotated. The hot wind which is heated to the temperature of 70 to 120° C., preferably 100° C. by means of a burner, is supplied to the input opening 34 and the output opening 36 at the wind speed of 1 to 3 m/sec, preferably 2 m/sec. The drum 30 is rotated at 6 to 8 rpm, preferably 12 rpm. The input conveyor 12 is operated while the drum 30 is maintained horizontally. The mash-products 2B, which are dried with 25 to 35% of content of the moisture by the first dry operation, are output at the rate of 2 to 4 kg/min, and subsequently transferred into the second drying can 22. After 20 to 40 minutes, preferably 25 minutes from the beginning of the inputting operation, the dried mash-products 2C are drawn out by proper opening of the opening and closing unit of the output opening.

At this time, the dried mash-products may be accumulated in the depressed portions for some time in the mixing rotary drying unit (the second drying unit), all of the mash-products are not subjected to the hot wind uniformly. For this reason, the mash-products may be bent if they are not dried evenly. Accordingly, in order to dry the mash-products evenly, the mash-products must be dried until they contain the content of the moisture (25 to 35%) with which they may not be bent to what extent in the flow rotary drying unit (the first drying unit), and then the mash-products must be adjusted finely until they contain the desired moisture in the mixing rotary drying unit (the second drying unit). Even if the content of the moisture in the mash-products input into the mixing rotary drying unit is not uniform, since the amount of the supplied hot wind is less, the mash-products containing more moisture can take the heat capacity necessary for vaporizing the moisture to be dried relatively fast, and ones containing less moisture do not take the heat capacity necessary for vaporizing the moisture to be dried relatively slow (referring to ┌drying device├, TOUEI RYOZO, nikkan kogyo shinbunsha, Feb. 10, 1980, pages 12-13). As a result, the mash-products are dried uniformly at the output opening.

The fine adjusting in the second drying operation will now be described. The temperature of the hot wind or the angle of inclination of the drum 30 is adjusted, thereby it is possible to carry out the adjusting operation more finely and easily than the prior art. In addition, the angle of inclination of the drum 30 is adjusted to the maximum after the drying operation, and at the same time the opening-closing unit of the output opening is fully opened, thereby it is possible to draw out the mash-products more rapidly and easily than the prior art.

According to one aspect of the method for drying the mash-products of the present invention, the 2-step method for drying the mash-products comprises the steps of: carrying out a first drying operation of the mash-products 2A; and carrying out a second drying operation of the mash-products 2B which has been dried by the first drying operation.

According to another aspect of the method for drying the mash-products of the present invention, the second drying operation comprises the steps of: rotating the drum 30; blowing the hot wind into the drum 30; throwing the first dried mash-products 2B into the input opening 34 by means of the input conveyor 12; dropping the input mash-products 2B into the inlet so that they are dried secondly in the rotating drum 30; and discharging the second dried mash-products 2C through the discharging opening 36, wherein the hot wind used for drying is circulated during the second drying operation, and at the same time the used hot wind is discharged.

### EXAMPLE

According to one preferred embodiment of the present invention, reducing starchy resolution substance (for example, D-sorbitol, millet jelly, etc.) amount of which are as two times as that of the aforesaid patent were added, the frozen mash-products 2A formed by a prescribed process were cut by 1.0 mm in thickness, and then transferred into the first drying unit via the input fan 8, at the rate of 6 kg/min. In the first drying unit 10, the hot wind 24 having the temperature of 70° C. was supplied to the input opening 34 at the speed of 7.5 m/sec and to the output opening 36 at the speed of 5.5 m/sec. The rotating speed of the drum 30 was 4 rpm. The blown mash-products 2A were floated and flowed, and then were moved to the output opening slowly. As the mash-products were moved th the output, the rate of float and flow were lowered. Under this condition, the drum 30 was inclined while the output opening 36 was opened so that the mash-products 2B was discharged by 4 kg/min after 15 minutes. The content of the moisture of the continuously discharged mash-products 2B was 25.7%.

Subsequently, the mash-products were transferred into the second drying unit 20, in which the temperature of the hot wind was set to 110° C., and the speed of the hot wind was set to approximately 1.0 m/sec both for the input opening and the output opening. And then, the mash-products were blown into the uneven drum 30 rotating at 9 rpm by means of the input conveyor 12. The blown semi-dried mash-products 2B were mixed with the hot wind 24, and transferred to the output opening 36 slowly.

Under this condition, the drum 30 was inclined while the output opening 36 was opened so that the mash-products 2B was discharged by 3.3 kg/min after 20 minutes. The content of the moisture of the continuously discharged mash-products 2B was 11.5%.

According to the method and device for drying the mash-products of the invention, the mash-products are input continuously during the first drying operation, floated and flowed heavily, dried with the condition that they are flat and they have the moisture with which any bending or adhesion are not caused, and output successively. Afterwards, the mash-products are transferred to the second drying operation. In the second drying operation, since the inner surface area of the drum is large, the drum are rotated very fast, the mash-products are mixed satisfactorily with the hot wind. Further, since the hot wind of low speed is supplied, the mash-products are not flown away toward the output opening, and thus it is possible to adjust the content of the moisture of the mash-products more finely and easily than the prior art. Consequently, it is possible to maintain the mash-products under the optimal dried condition without any skill of operators. In addition, during the second drying operation, since the used hot wind is circulated and then reused, it is possible to save on energy. Also, since the angle of inclination of the plunger can be adjusted after the drying operation, the dried mash-products can be discharged more easily.

What is claimed is:

1. A 2-step device for drying mash-products, comprising:
a first drying unit (a flow rotary drying unit) (10); and
a second drying unit (a mixing rotary drying unit)(20),
wherein said first drying unit and said second drying unit are arranged in a series.

2. The device according to claim 1, wherein said second drying unit (the mixing rotary drying unit) (20) comprises:
a drying can (22) provided at the lower side portion thereof with an input opening (26) through which the hot wind (24) is input, and provided at the upper portion thereof with an output opening (28) through which the wasted hot wind is discharged;
a drum provided at the part thereof located inside the drying can (22) with holes and a corrugated portion (32) made of teflon-coated metal net, said drum being provided at one end thereof with an input opening (34), and being provided at the other end thereof with an output opening (36);
two or more dampers provided for adjusting the flow rate of the hot wind (24); and
a plunger (38) provided for adjusting the angle of inclination of the drum (30).

3. A mixing rotary device for drying mash-products, comprising:
a drying can (22) provided at the lower side portion thereof with an input opening (26) through which the hot wind (24) is input, and provided at the upper portion thereof with an output opening (28) through which the wasted hot wind is discharged;
a drum provided at the part thereof located inside the drying can (22) with holes and a corrugated portion (32) made of teflon-coated metal net, said drum being provided at one end thereof with an input opening (34), and being provided at the other end thereof with an output opening (36);
two or more dampers provided for adjusting the flow rate of the hot wind (24); and
a plunger (38) provided for adjusting the angle of inclination of the drum (30).

4. A 2-step method for drying mash-products, comprising the steps of:
carrying out a first drying operation of the mash-products; and
carrying out a second drying operation of the mash-products (2B) which has been dried by the first drying operation,
wherein said first drying operation comprises the steps of: blowing the cut mash-products; rotating the drum; blowing the hot wind into the drum; and discharging the dried mash-products,.
and wherein said second drying operation comprises the steps of: rotating the drum (30); blowing the hot wind into the drum (30); throwing the first dried mash-products (2B) into the input opening (34) by means of the input conveyor (12); dropping the input mash-products (2B) into the inlet so that they are dried secondly in the rotating drum (30); and discharging the second dried mash-products (2C) through the discharging opening (36),
said hot wind used for drying being circulated during the second drying operation, and at the same time said used hot wind being discharged.

5. The method according to claim 4, wherein three dampers are arranged at the input opening (34), the middle portion thereof, and the output opening (36) so that the flow rate of the hot wind is adjusted equally at said three position when the hot wind (24) is blown during the second drying operation.

6. The method according to claim 4, wherein said drum is rotated at 3 to 6 rpm during the first drying operation, and said drum (30) is rotated at 6 to 18 rpm during the second drying operation.

7. The method according to claim 4, wherein the blowing temperature of the hot wind is 50 to 70° C. during the first drying operation, and the blowing temperature of the hot wind (24) is 70 to 120° C. during the second drying operation.

8. The method according to claim 4, wherein the blowing speed of the hot wind is 6 to 8 m/sec at the inlet thereof and 4 to 6 m/sec at the outlet thereof during the first drying operation, and the blowing speed of the hot wind is 1 to 3 m/sec during the second drying operation.

9. The method according to claim 4, wherein the drying time of the first drying operation is 10 to 20 minutes, and the drying time of the second drying operation is 20 to 40 minutes.

10. The method according to claim 4, wherein the content of the moisture of the mash-products (2A) which are blown into during the first drying operation is 45 to 60%, and the content of the moisture of the mash-products (2B) which are blown into during the second drying operation is 25 to 35%.

11. The method according to claim 4, further comprising an opening and closing unit of the output opening for adjusting the amounts of the discharged mash-products as means for adjusting the content of the moisture before the discharging the dried mash-products (2C) through the output opening (36).

12. The method according to claim 4, wherein the fine adjusting of the content of the moisture of the dried mash-product (2C) is carried out by controlling the temperature of the hot wind 24.

13. The method according to claim 12, wherein the fine adjusting of the content of the moisture of the dried mash-product (2C) is carried out by controlling the angle of inclination of the drum (30) by means of the plunger (38).
